(19) United States
(12) Patent Application Publication
(10) Pub. No.: US 2010/0237146 A1
(43) Pub. Date: Sep. 23, 2010

(54) CARD AUTHENTICATION SYSTEM AND METHOD

(75) Inventor: Michael George Turner, Wellington (NZ)

Correspondence Address: SCHWEGMAN, LUNDBERG & WOESSNER, P.A., P.O. BOX 2938, MINNEAPOLIS, MN, 55402, US

(73) Assignee: Bank of New Zealand, Auckland (NZ)

(21) Appl. No.: 12/741,939

(22) PCT Filed: Oct. 20, 2008
(86) PCT No.: PCT/NZ2008/000269

§ 371 Date: May 7, 2010

(30) Foreign Application Priority Data
Nov. 14, 2007 (NZ) 563415

(51) Int. Cl. G06K 5/00

(52) U.S. Cl. 235/380

(57) ABSTRACT

The invention provides a method for performing card authentication of a bank card. The method comprises reading a first liquid encoded number (LEN_{card}) from a bank card; transmitting the LEN_{card} to an authorisation server, the authorisation server interfaced to an authorisation database; retrieving at least a further liquid encoded number (LEN_{current}) from the authorisation database; and comparing LEN_{card} and LEN_{current}. If the LEN_{card} is not equal to the LEN_{current} then if the bank card is a new card, the method includes processing the bank card as a new card otherwise processing the bank card as a fraudulent card. If the LEN_{card} equals the LEN_{current}, then the method includes generating a further liquid encoded number (LEN_{new}); writing the LEN_{new} to the bank card in place of the LEN_{card}; and writing the LEN_{new} to the authorisation database in place of the LEN_{current}.

### FIELD OF INVENTION

The present invention relates to a method and system for card authentication, particularly suited to reducing fraud through the use of unauthorised copies of bank cards.

### BACKGROUND TO INVENTION

Japanese patent specification JP 2005038220 assigned to Hitachi Software Eng Co Limited describes a system for early detection of fraudulent use of illegally copied cards. Code information collected for each card in a credit company settlement system is stored both in settlement system storage means and in credit card storage means. Every time a card is used the two numbers are checked. If the code information coincides then the card is judged to be normal. During the settlement process the code information is changed and new code information overwritten in the settlement system and in the credit storage means. Where the code information does not match it is assumed that the card use is fraudulent.

One difficulty with the Hitachi system is that it requires each merchant to have the capability to write to individual cards. In most electronic card readers the merchant has permission only to read from a card. If a merchant is unable to write to a card then it is not possible to change the code information each time a card is used.

The Hitachi system is perhaps best suited to use of a credit card within a limited group of participating merchants that are able to write to credit cards. The Hitachi system is not suited to a wider range of diverse merchants across geographical boundaries.

One further difficulty of the Hitachi system is how the system would deal with the issuing of new or replacement cards. It is common practice for financial institutions to issue a new or replacement card up to one month before expiry of an existing card. In the Hitachi system the new or replacement card would have loaded on it the current code information. If a customer were to use an existing card following issuance of a new or replacement card then the code information on the existing card and in the system would change following use of the existing card. The code information in the system would no longer match the code information on the new card and so the customer's first use of the new card would inadvertently be deemed fraudulent.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of the present invention to provide an improved or alternative method for performing a financial transaction, or to at least provide the public with a useful choice.

### SUMMARY OF THE INVENTION

The invention in one aspect provides a method for performing card authentication of a bank card. The method comprises reading a first liquid encoded number (LEN_{card}) from a bank card; transmitting the LEN_{card} to an authorisation server, the authorisation server interfaced to an authorisation database; retrieving at least a further liquid encoded number (LEN_{current}) from the authorisation database; and comparing LEN_{card} and LEN_{current}.

If the LEN_{card} is not equal to the LEN_{current} then if the bank card is a new card, the method includes processing the bank card as a new card otherwise processing the bank card as a fraudulent card.

If the LEN_{card} equals the LEN_{current}, then the method includes generating a further liquid encoded number (LEN_{new}); writing the LEN_{new} to the bank card in place of the LEN_{card}; and writing the LEN_{new} to the authorisation database in place of the LEN_{current}.

The term “comprising” as used in this specification and claims means “consisting at least in part of”. That is to say, when interpreting statements in this specification and claims which include “comprising”, the features prefaced by this term in each statement all need to be present but other features can also be present. Related terms such as “comprise” and “comprised” are to be interpreted in a similar manner.

Preferably the method further comprises retrieving at least a further liquid encoded number (LEN _{future}) from the authorisation database.

Preferably the bank card is assumed to be a new card if LEN_{card} is equal to LEN_{future}.

Preferably processing the bank card as a new card comprises writing the LEN_{future} to the authorisation database in place of the LEN_{current}; setting the LEN_{future} in the authorisation database to null; generating the LEN_{new}; writing the LEN_{new} to the bank card in place of the LEN_{card}; and writing the LEN_{new} to the authorisation database in place of the LEN_{current}.

Preferably the method further comprises retrieving at least a further liquid encoded number (LENₚᵣₑᵥᵢₒᵤₛ) from the authorisation database.

Preferably if the LEN_{card} equals the LEN_{current} then the method includes writing the LEN_{current} to the authorisation database in place of the LENₚᵣₑᵥᵢₒᵤₛ; on detecting an unsuccessful write of LEN_{new}to the card, writing the LENₚᵣₑᵥᵢₒᵤₛ to the authorisation database in place of the LEN_{current}.

Preferably the method further comprises writing a predetermined wild card value to the authorisation database in place of the LEN_{current}. If the LEN_{card} is not equal to the LEN_{current} then the method includes writing the LEN_{card} to the authorisation database in place Of the LEN_{current}; processing the card as if LEN_{card} equals LEN_{current}.

Preferably the method further comprises determining if LEN_{card} and the transaction are both within a predefined range.

Preferably if the LEN_{card} is not equal to the LEN_{current} and LEN_{card} and the transaction are both within the predefined range then the method includes processing the card as if LEN_{card} equals LEN_{current}.

Preferably the method further comprises processing the card as if LEN_{card} equals LEN_{current} when both LEN_{card} is equal to LEN_{current} and LEN_{card} and the transaction are not within the predefined range.

Preferably the method further comprises providing an override option.

Preferably the method further comprises, if the LEN_{card} is not equal to the LEN_{current}, then activating the override option at the option of a human operator; writing the LEN_{card} to the authorisation database in place of the LEN_{current}; and processing the card as if LEN_{card} equals LEN_{current}.

Preferably the method further comprises, if the LEN_{card} is not equal to the LEN_{current}, then activating the override option using an automated process; writing the LEN_{card} to the authorisation database in place of the LEN_{current}; and processing the card as if LEN_{card} equals LEN_{current}.

The invention in another aspect provides a computer readable medium having computer executable instructions for performing a method for performing card authentication of a bank card. The method comprises reading a first liquid encoded number (LEN_{card}) from a bank card; transmitting the LEN_{card} to an authorisation server, the authorisation server interfaced to an authorisation database; retrieving at least a further liquid encoded number (LEN_{current}) from the authorisation database; and comparing LEN_{card} and LEN_{current}.

If the LEN_{card} is not equal to the LEN_{current} then if the bank card is a new card, the method includes processing the bank card as a new card otherwise processing the bank card as a fraudulent card.

If the LEN_{card} equals the LEN_{current}, then the method includes generating a further liquid encoded number (LEN_{new}); writing the LEN_{new} to the bank card in place of the LEN_{card}; and writing the LEN_{new} to the authorisation database in place of the LEN_{current}.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1 shows a preferred form system in which the techniques for performing a financial transaction described below can be implemented.

FIG. 2 shows a preferred form process for managing card authentication at a device authorised to write to a bank card.

FIG. 3 shows a preferred form process for managing card authentication at a device not authorised to write to a bank card.

### DETAILED DESCRIPTION

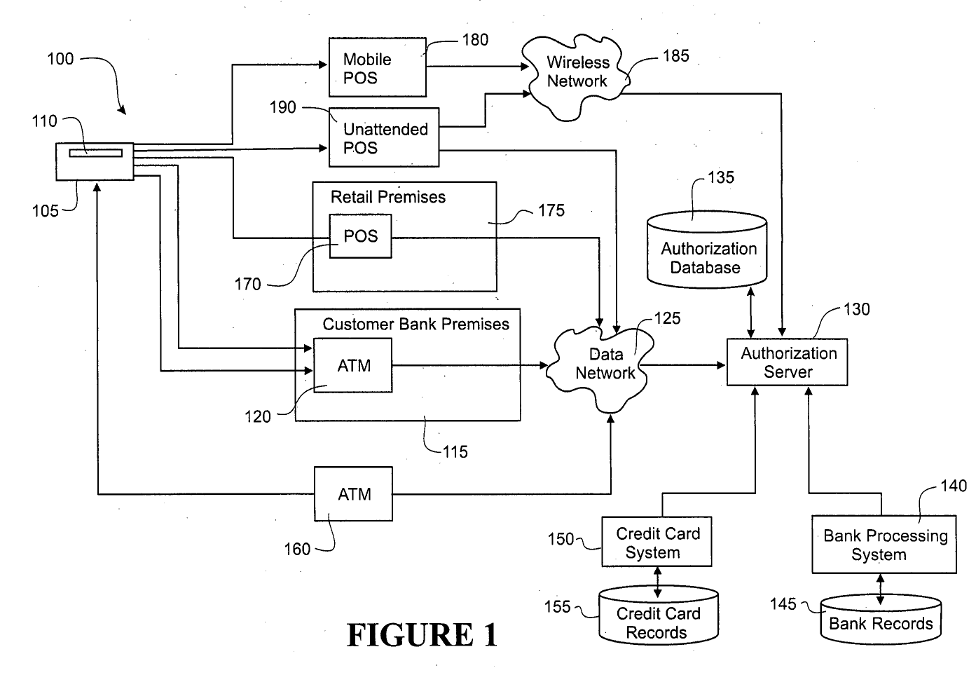

FIG. 1 shows a preferred form system 100 in which one technique for performing financial transactions can be implemented. A customer (not shown) is the holder of a bank card 105. Bank card 105 is issued by a bank with which the customer holds one or more accounts. This bank is referred to in the specification as a customer bank. The bank card 105 shown in FIG. 1 is a magnetic stripe card having a magnetic strip or stripe 110 affixed to the bank card. Data is stored in magnetic stripe 110 according to a predefined data format. Varying data formats will be described below.

It will be appreciated that bank card 105 could additionally include data stored on a chip affixed or integral with the bank card 105. Such cards are referred to as chip cards or integrated circuit (IC) cards.

Bank cards include many types of payment cards comprising but not limited to debit cards, credit cards, prepaid cards, and chargecards.

The bank card 105 is used to purchase items, withdraw funds, deposit funds, transfer funds from one account to another electronically, check account balances, or perform any other function. Customer bank typically has several premises, one of which is indicated at 115. Customer bank premises 115 owns, deploys and/or controls ATM 120. ATM 120 may or may not be sited at or near customer bank premises. Sited at or near customer bank premises 115 is an automatic teller machine or ATM 120. ATM 120 typically includes a card reader/writer to read data from and write data to card 105. The ATM also includes a display to display information to a customer as well as a mechanism for dispensing withdrawn funds. Some ATM machines include a mechanism for accepting deposited funds.

When a customer uses an ATM 120, various data is read from magnetic stripe 110 such as a card number. In order to operate the ATM using bank card 105, the customer swipes or dips bank card 105 into or through the card reader/writer or inserts bank card into the card reader/writer.

The ATM typically includes a keypad with which a user enters a multi-digit personal identification number or PIN. The PIN is usually at least 4 digits in length. Some ATM machines include other methods of card holder authentication. The ATM 120 receives a user entered PIN and transmits this PIN together with at least card authorisation data over data network 125 to an authorisation server 130. The authorisation server 130 is interfaced to authorisation database 135.

An alternative to ATM machines is the tellers' platform. A tellers' platform is situated within a bank branch. The platform includes a card reader/writer device connected to the host system of the bank. The platform is used to conduct banking transactions. A customer bank card can be used to assist in the customer authentication process prior to undertaking customer requested transactions such as cash deposit/withdraw, balance enquiry, statements and so on.

Authorisation database 135 includes stored details of customer accounts and funds balances for each account. If the PIN is correct then the financial transaction is typically approved. Approval confirmation is transmitted from authorisation server 130 over data network 125 to ATM 120.

Authorisation database 135 is also in communication with bank processing system 140 and bank records 145 as well as card processing system 150 and credit card records 155. In most cases updates in the authorisation database will be transmitted in realtime or batches to bank processing system 140 and/or bank card processing system 150.

As shown in FIG. 1, system 100 further includes ATM 160 that is not operated by, nor is sited at, the customer bank premises. Also included is point of sale (POS) terminal 170 sited at a retail premises 175 and mobile POS terminal 180. Also included is unattended POS systems 190 which connect to either wireless network 185 or data network 125 as appropriate. The systems are further described below. It is anticipated that the systems are divided into two logical groups.

The first group comprises authorised devices. Authorised devices are permitted to write data to the bank card. It is anticipated that these authorised devices will be a particular financial service provider ATMs and other devices where the cardholder's bank has agreement to write to the bank card.

The second group of devices are devices that are not authorised to write to a bank card. These devices are permitted to read only.

As will be further described below, system 100 includes an additional authorisation check before approving a financial transaction. Stored on magnetic stripe 110 is a Liquid Encoded Number (LEN). Such a value stored on a card is referred to below as a LEN_{card}. The LEN_{card} is stored in a data field in magnetic stripe 110 and is typically three bytes but can be smaller or greater in length depending on the business requirements. The LEN_{card} is not known to the customer and does not need to be entered on the keypad of the ATM 120.

Authorisation database 135 also includes a LEN associated with the customer account. This value is referred to below as a LEN_{current}.

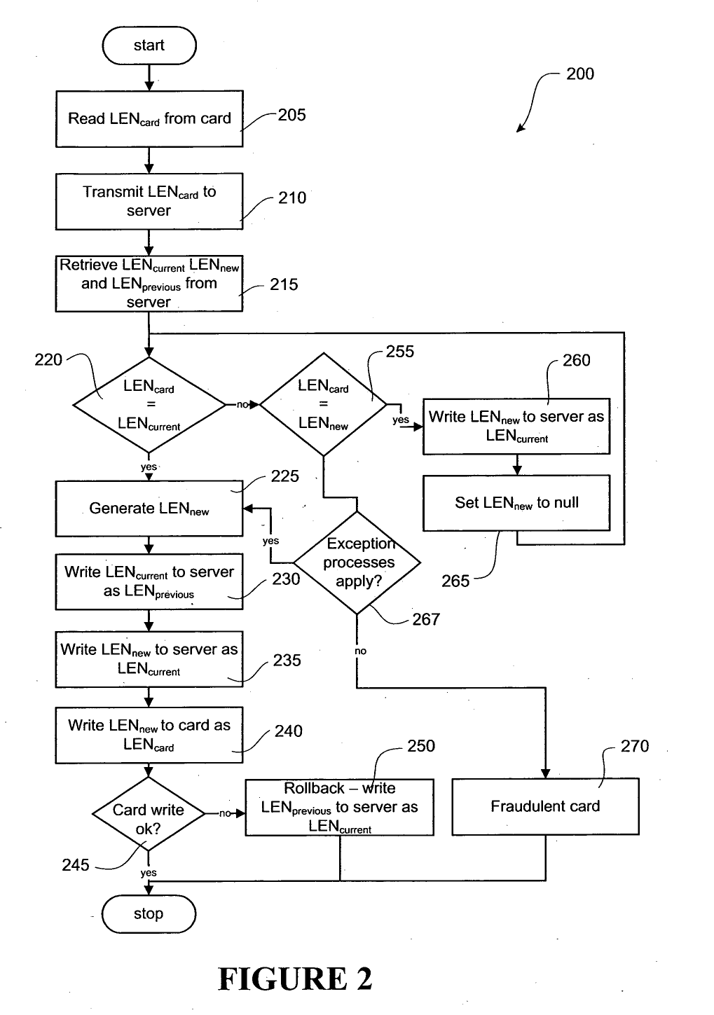

FIG. 2 shows a preferred form process 200 for managing card authentication at a bank controlled premises 115 or on a bank controlled device 220 in which writes are permitted to the card. These are authorised devices. ATM 120 reads 205 the LEN_{card} from the appropriate field in the magnetic stripe card 110 on the bank card 105. This LEN_{card} is transmitted 210 over the data network to the authorisation server 130 along with the other usual details such as card authorisation data.

The corresponding LEN_{current} is retrieved from 215 the authorisation database. In preferred embodiments two further LENs are maintained in the authorisation database.

One of these values is a future LEN (LEN _{future}) that is loaded onto replacement cards or new cards issued to a customer.

Also maintained is a previous LEN (LENₚᵣₑᵥᵢₒᵤₛ). Every time a LEN_{current} is assigned a further value, the current value at that time is stored in the authorisation database as a LENₚᵣₑᵥᵢₒᵤₛ.

Step 215 includes retrieving at least the LEN_{current} from the server. The step optionally further includes retrieving the LEN_{future} and/or the LENₚᵣₑᵥᵢₒᵤₛ from the authorisation database.

If the LEN_{card} is equal 220 to LEN_{current} then the card is not automatically declined. The transaction proceeds through the usual checks such as for valid customer number, sufficient funds in the account, and valid card expiry date.

A preferred form comparison between the LEN_{current} and the LEN_{card} is a string comparison or a numeric value comparison that requires equality.

A new value LEN_{new} is then randomly generated 225. The LEN_{new} is different to the LEN_{card} and LEN_{current}. In this case the LEN_{card} and LEN_{current} will be equal. This LEN_{new} is then transmitted over the data network 125 to the ATM 120.

The LEN_{current} which was previously the current value is written 230 to the authorisation database in place of the LENₚᵣₑᵥᵢₒᵤₛ.

The LEN_{new} is also written 235 to the authorisation database in place of the LEN_{current} so that the LEN_{new} replaces the LEN_{current} in the authorisation database.

The card reader/writer in the ATM 120 writes 240 the LEN_{new} to the bank card 105 in place of the LEN_{card}. The LEN_{new} overwrites the LEN_{card} on the bank card.

If there is a card write error 245 then a roll back procedure 250 is followed. In this roll back procedure the LENₚᵣₑᵥᵢₒᵤₛ is written to the authorisation database as LEN_{current} which has the effect of rolling back changes to the values.

At step 220 above the LEN_{current} is compared with the LEN_{card}. In some circumstances there will be valid reasons why the two values do not match and it is not appropriate to automatically decline the financial transaction.

When a new card or replacement card is issued to a customer, the LEN_{card} on the new card is stored both on the new card and in the authorisation database as LEN_{future}. When a customer first uses the replacement or new card at ATM 120, the LEN_{card} read from the replacement or new card will not match the LEN_{current} retrieved from the authorisation database. The LEN_{current} is the authorisation value stored on the old card.

If the LEN_{card} read from the card does not match the LEN_{current} then the LEN_{card} read from the card is checked 255 for identity with the LEN_{future}. If there is a match between the LEN_{card} and the LEN_{future} then it is assumed that the customer has used the replacement or new card for the first time at ATM 120 provided that the customer has supplied the correct PIN.

The LEN_{current} in the authorisation database is then set 260 to the LEN_{future}. The LEN_{future} is set 265 to null. The LEN_{card} now matches the LEN_{current} and so control then passes to generate a LEN_{new} as set out in steps 225 onwards.

If LEN_{card} does not match LEN_{new} then exception processes are tested 267 to see if they apply.

One reason to apply an exception is where there is a mismatch between LEN_{current}, and LEN_{card} values caused by an error writing to the card. In some cases this error may not be handled adequately by the rollback procedure 250. LEN_{card} would not match LEN_{current}. Where it can be determined that there has previously been an error writing to the card, LEN_{current} in the authorisation database is set to LEN_{card}. The current transaction and subsequent transactions are allowed.

Another reason for a mismatch is caused by unexpected customer behaviour. In some cases a customer reports a card broken and orders one or more replacement cards. These cards are then either kept in multiple places for the use of the customer, or distributed to family members of the customer. Where it can be determined that multiple identical cards exist, one of the cards is deemed to be the correct card as it will have the LEN_{card} read from the card equal to LEN_{current} read from the authorisation database. The other multiple cards will have different LEN_{card} values that do not match the LEN_{current}. Transactions with those cards will be declined.

A further reason for a mismatch is that some vendor terminals do not read LEN_{card} values properly. The readers return an invalid string such as “014” instead of the actual LEN_{card} value.

In these cases the system follows an exception. An example exception is that if LEN_{current} is “000” and does not match LEN_{card} then the transaction is processed as an approved transaction.

In some cases it is appropriate to set LEN_{current} to a “wild card” value. One example of this situation is where it is known that there are two identical initialised cards in circulation. Another reason is where it is known there has been a device error at a card reader/writer. There are many error codes from ATM readers/writers and these will be different depending on ATM and Host Processor. LEN_{current} is set to a predetermined wild card value. If LEN_{card}<>LEN_{current} and LEN_{current} is the wild card value, then LEN_{card} and LEN_{current} are treated as though they match and LEN_{current} is updated with LEN_{card}. The card is updating the authorisation database.

In addition in some cases it is appropriate to provide a manual override option, or automatic LEN_{current} override function. The LEN_{card} is treated as correct. The LEN_{current} is updated with the LEN_{card} value. One example of this situation is where the cardholder has successfully identified themselves to a bank teller. The cardholder has an inoperable card due to a LEN mismatch.

If LEN_{card} is not equal to LEN_{current} and the cardholder has successfully identified themselves to the bank teller using additional forms of identification, then the teller activates the manual override option. The LEN_{card} is treated as correct. LEN_{card} and LEN_{current} are treated as though they match. The LEN_{current} is updated with the LEN_{card}.

Another situation is where The cardholder has successfully identified themselves in some other manner. In one embodiment the override option is activated using an automated process.

This LEN override function enables the card to update the authorisation database.

In other cases it is appropriate to ignore specific ranges of LEN_{card} values for transactions which meet specific criteria as determined from time to time. For example it may be appropriate to decide to approve all transactions in one or more countries but to check all transactions in other countries. There are criteria/ranges for the New Zealand market that may differ between card issuers in other markets. The concept is to manage exception data and determine to process it as either a valid accepted or valid decline transaction. This business decision can be effected in more than one way. One way is to treat LEN_{card} and LEN_{current} values as though they match if LEN_{card}<>LEN_{current} plus LEN_{card} and the transaction are both within a predefined range/criteria. Another way is to check for a match between LEN_{card} and LEN_{current} only if LEN_{card} and the transaction are both not within a predefined range/criteria.

This would apply where it is appropriate to decide to approve all transactions in a customer's home country (for example New Zealand) and/or a further country (for example Australia).

If the LEN_{card} does not match either of the LEN_{current} or the LEN_{future}, or is not a valid mismatch exception then it is assumed that it is a fraudulent card 270 and the transaction is declined.

The process described above involves a customer using a bank card at an ATM at a customer bank premises. In some preferred forms of the invention, the customer uses the bank card 105 at ATM 160 that is not operated by, nor is sited at, the customer bank premises. Writes are not permitted to the card. In one embodiment, the LEN_{card} on bank card 105 is updated as described above. In another form of the invention the LEN_{card} is not updated as described above if the bank card is used in an ATM operated by a bank other than the customer bank.

In a further embodiment the customer uses bank card 105 at a point of sale (POS) terminal 170 sited at a retail premises 175. Data read from the card is transmitted over data network 125 to authorisation server 130 as described above. In one embodiment the LEN_{card} is read by a card reader/writer forming part of POS terminal 170. The authorisation value is checked against a stored authorisation value in the authorisation database 135 as described above. The third authorisation value could be defined and written to the card 105 through POS terminal 170. It is envisaged that appropriate security measures are in place so that the newly generated authorisation value is not intercepted at or about the retail premises 175.

In a further embodiment the customer uses mobile point of sale terminal (POS) 180. The mobile POS 180 retrieves data from the card 105 and transmits this data over a wireless network to authorisation server 130. In one embodiment the LEN_{card} is read from the card and is checked against a stored LEN_{current} stored in the authorisation database. It is envisaged that the third authorisation value is not regenerated and transmitted over the wireless network. If there are appropriate security procedures in place it is envisaged that the third authorisation value could be regenerated and transmitted over the wireless network to the mobile POS 180 to be written to card 105.

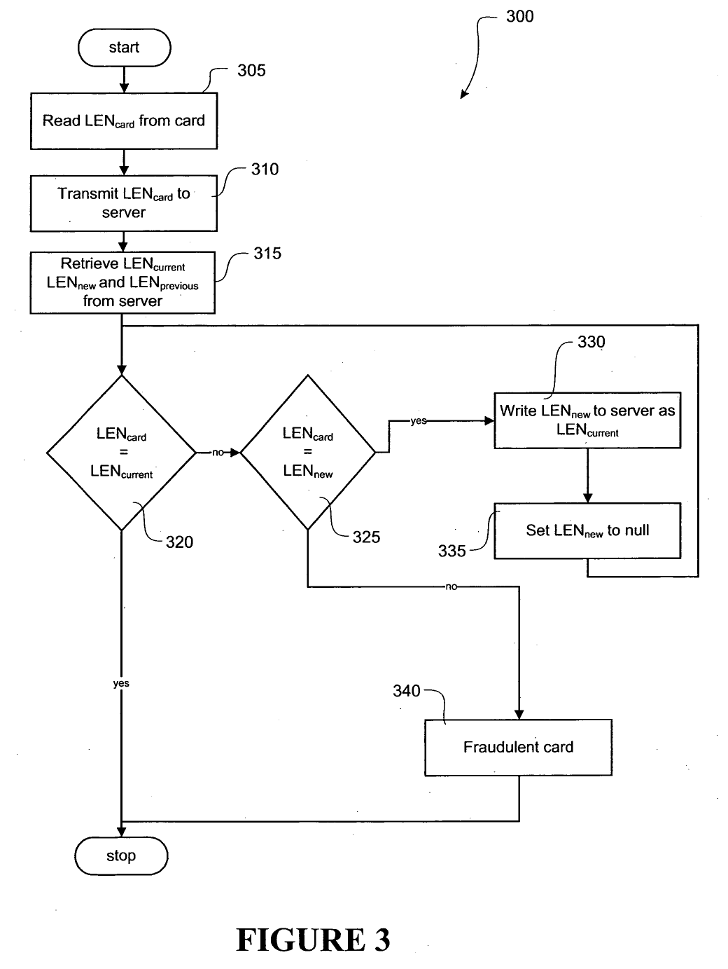

FIG. 3 shows at 300 a preferred form method in which a customer uses a device that is not authorised to make updates to a customer bank card. Steps 305, 310 and 315 proceed in the same manner as steps 205, 210 and 215 from FIG. 2. The ATM or other device not authorised reads 305 the LEN_{card} from the card. This LEN_{card} is transmitted 310 over the data network, either wireless or wired, to the authorisation server 130 along with other usual details such as account number and entered PIN if appropriate. The corresponding LEN_{current}, LEN_{future} and LENₚᵣₑᵥᵢₒᵤₛ are retrieved 315 from the server.

LEN_{card} is compared 320 with LEN_{current}. If LEN_{card} is equal to LEN_{current} then the card is not automatically declined. The transaction proceeds through the usual checks such as for valid card number, sufficient funds in the account and valid card expiry date. A LEN_{new} value is not generated nor written to the bank card.

If LEN_{card} is not equal to LEN_{current} then the system compares 325 LEN_{card} with LEN_{future}. The two values will be equal where a new card or replacement card has been issued to a customer. If there is a match between LEN_{card} and LEN _{future} then it is assumed that the customer has used the replacement or new card for the first time at the device.

The LEN_{current} in the authorisation database is set 330 to the LEN_{new}. The LEN_{future} is set 335 to null. The LEN_{card} now matches the LEN_{current} and so control then passes to check LEN_{card} against LEN_{current}. As described above a LEN_{new} value is not generated nor written to the bank card.

If the LEN_{card} does not match either of the LEN_{current} or the LEN_{new}, or is not a valid mismatch exception then it is assumed that it is ,a fraudulent card 340 and the transaction or other financial operation is declined.

The techniques described above are particularly suited to instances of fraud where a merchant or other party having access to a POS terminal or ATM makes an identical copy of the data stored on a bank card or have access to where data is stored, or intercept the data and creates a counterfeit bank card having identical data. It will be appreciated that where a PIN is required for some financial transactions, the PIN can also be obtained by a counterfeit party.

The LEN_{card} on the card is updated periodically, for example when a customer uses an ATM at a customer bank or authorised device. Once the authorisation number or authorisation value on the customers card has been changed, attempted use of the counterfeit bank card will generate a “transaction declined” message each time it is used.

The foregoing describes the invention including preferred forms thereof. Modifications and improvements as would be obvious to those skilled in the art are intended to be incorporated in the scope hereof as defined in the accompanying claims.

1. A method for performing card authentication of a bank card comprising:
reading a first liquid encoded number (LEN_{card}) from a bank card;
transmitting the LEN_{card} to an authorisation server, the authorisation server interfaced to an authorisation database;
retrieving at least a further liquid encoded number (LEN_{current}) from the authorisation database;
comparing LEN_{card} and LEN_{current}; and
if the LEN_{card} is not equal to the LEN_{current} then:
if the bank card is a new card, processing the bank card as a new card, and
if the bank card is not a new card, processing the bank card as a fraudulent card; and
if the LEN_{card} equals the LEN_{current}, then:
generating a further liquid encoded number (LEN_{new});
writing the LEN_{new} to the bank card in place of the LEN_{card}; and
writing the LEN_{new} to the authorisation database in place of the LEN_{current}.

2. The method of claim 1 further comprising retrieving at least a further liquid encoded number (LEN_{future}) from the authorisation database.

3. The method of claim 2 wherein the bank card is assumed to be a new card if LEN_{card} is equal to LEN_{future}.

4. The method of claim 3 wherein processing the bank card as a new card comprises:
writing the LEN_{future} to the authorisation database in place of the LEN_{current};
setting the LEN_{future} in the authorisation database to null;
generating the LEN_{new};
writing the LEN_{new} to the bank card in place of the LEN_{card}; and
writing the LEN_{new} to the authorisation database in place of the LEN_{current}.

5. The method of claim 1 further comprising retrieving at least a further liquid encoded number (LENₚᵣₑᵥᵢₒᵤₛ) from the authorisation database.

6. The method of claim 5 further comprising if the LEN_{card} equals the LEN_{current} then:
writing the LEN_{current} to the authorisation database in place of the LENₚᵣₑᵥᵢₒᵤₛ;
on detecting an unsuccessful write of LEN_{new} to the card, writing the LENₚᵣₑᵥᵢₒᵤₛ to the authorisation database in place of the LEN_{current}.

7. The method of claim 1 further comprising:
writing a predetermined wild card value to the authorisation database in place of the LEN_{current};
if the LEN_{card} is not equal to the LEN_{current} then:
writing the LEN_{card} to the authorisation database in place of the LEN_{current};
processing the card as if LEN_{card} equals LEN_{current}.

8. The method of claim 1 further comprising:
determining if LEN_{card} and the transaction are within a predefined range.

9. The method of claim 8 further comprising:
if the LEN_{card} is not equal to the LEN_{current} and LEN_{card} and the transaction are both within the predefined range then processing the card as if LEN_{card} equals LEN_{current}.

10. The method of claim 8 further comprising:
processing the card as if LEN_{card} equals LEN_{current} when both LEN_{card} is equal to LEN_{current} and LEN_{card} and the transaction are not within the predefined range.

11. The method of claim 1 further comprising:
providing an override option.

12. The method of claim 11 further comprising:
if the LEN_{card} is not equal to the LEN_{current} then:
activating the override option at the option of a human operator;
writing the LEN_{card} to the authorisation database in place of the LEN_{current}; and
processing the card as if LEN_{card} equals LEN_{current}.

13. The method of claim 11 further comprising:
if the LEN_{card} is not equal to the LEN_{current} then:
activating the override option using an automated process;
writing the LEN_{card} to the authorisation database in place of the LEN_{current}; and
processing the card as if LEN_{card} equals LEN_{current}.

14. A computer readable medium having computer executable instructions for performing a method for performing card authentication of a bank card, the method comprising:
reading a first liquid encoded number (LEN_{card}) from a bank card;
transmitting the LEN_{card} to an authorisation server, the authorisation server interfaced to an authorisation database;
retrieving at least a further liquid encoded number (LEN_{current}) from the authorisation database;
comparing LEN_{card} and LEN_{current}; and
if the LEN_{card} is not equal to the LEN_{current} then if the bank card is a new card, processing the bank card as a new card otherwise processing the bank card as a fraudulent card; and
if the LEN_{card} equals the LEN_{current}, then:
generating a further liquid encoded number (LEN_{new});
writing the LEN_{new} to the bank card in place of the LEN_{card}; and
writing the LEN_{new} to the authorisation database in place of the LEN_{current}.

15. A method for performing card authentication of a bank card comprising:
receiving at an authorisation server a first liquid encoded number (LEN_{card}) read from a bank card, the authorisation server interfaced to an authorisation database;
retrieving at least a further liquid encoded number (LEN_{current}) from the authorisation database;
comparing LEN_{card} and LEN_{current}; and
if the LEN_{card} is not equal to the LEN_{current} then:
if the bank card is a new card, processing the bank card as a new card, and
if the bank card is not a new card, processing the bank card as a fraudulent card.

16. A method for performing card authentication of a bank card as claimed in claim 15 further comprising:
if the LEN_{card} equals the LEN_{current}, then:
generating a further liquid encoded number (LEN_{new});
writing the LEN_{new} to the bank card in place of the LEN_{card}; and
writing the LEN_{new} to the authorisation database in place of the LEN_{current}.

17. A method for performing card authentication of a bank card comprising:
reading a first liquid encoded number (LEN_{card}) from a bank card;
transmitting the LEN_{card} to an authorisation server, the authorisation server interfaced to an authorisation database; and
if the LEN_{card} is not equal to a further liquid encoded number (LEN_{current}) retrieved from the authorisation database then:
if the bank card is a new card, processing the bank card as a new card, and
if the bank card is not a new card, processing the bank card as a fraudulent card.
